(19) United States
(12) Patent Application Publication
(10) Pub. No.: US 2017/0193349 A1
(43) Pub. Date: Jul. 6, 2017

(54) CATEGORIZATIONING AND PRIORITIZATION OF MANAGING TASKS

(71) Applicant: Microsoft Technology Licensing, LLC, Redmond, WA (US)

(72) Inventors: Raghu Jothilingam, Hyderabad (IN); Sanal Sundar, Hyderabad (IN)

(21) Appl. No.: 14/984,054

(22) Filed: Dec. 30, 2015

(51) Int. Cl. G06N 3/00; G06N 99/00

(52) U.S. Cl. CPC G06N 3/006; G06N 99/005

(57) ABSTRACT

Techniques and architectures manage tasks in an electronic communications environment, such as in electronic calendars, email accounts, displays, and databases. A computing system may determine a number of task-oriented actions based, at least in part, on a history of execution patterns followed by a particular user for performing particular tasks. Such a history may be generated or modified by a machine learning process. Task-oriented actions may include: prioritizing a set of tasks by using such a history in view of various parameters of each task; extracting an action, subject, and keyword from an individual task; generating a visual cue that represents various parameters of a set of tasks; and generating a productivity report that provides an analysis on the time spent by the user on different task categories.

### BACKGROUND

Electronic communications have become an important form of social and business interactions. Such electronic communications include email, calendars, SMS text messages, voice mail, images, videos, and other digital communications and content, just to name a few examples. Electronic communications are generated automatically or manually by users on any of a number of computing devices.

### SUMMARY

This disclosure describes techniques and architectures for managing tasks in an electronic communications environment, such as in electronic calendars, email accounts, and databases, just to name a few examples. A computing system may determine a number of task-oriented actions based, at least in part, on a history of execution patterns followed by a particular user for performing particular tasks. Such a history may be generated or modified by a machine learning process. Task-oriented actions may include: prioritizing a set of tasks by using such a history in view of various parameters of each task; extracting an action, subject, and keyword from an individual task; generating a visual cue that represents various parameters of a set of tasks; and generating a productivity report that provides an analysis on the time spent by the user on different task categories.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (AS SPs), System-on-a-chip systems (SOCs), Complex Programmable Logic Devices (CPLDs)), and/or other technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which techniques described herein may be implemented.

FIG. 2 is a block diagram illustrating electronic communication subjected to an example task extraction process.

FIG. 3 is a block diagram illustrating an electronic communication that includes an example text and a task extraction process of a task.

FIG. 4 is a block diagram of multiple information sources that may communicate with an example task operations module.

FIG. 5 is a block diagram of an example machine learning system.

FIG. 6 is a block diagram of example machine learning models.

FIG. 7 is a view of a display showing an example graphic including visual cues of tasks.

FIG. 8 is a view of a display showing an example graphic including productivity of performing tasks.

FIG. 9 is a view of a display showing an example task list.

FIG. 10 is a flow diagram of an example task management process.

FIG. 11 is a block diagram illustrating example online and offline processes for task parameter extraction.

FIG. 12 is a flow diagram of an example task categorization process.

### DETAILED DESCRIPTION

Various examples describe techniques and architectures for a system that performs, among other things, collection or extraction of tasks from databases, user accounts, and electronic communications, such as messages between or among one or more users (e.g., a single user may send a message to oneself or to one or more other users). For example, a system may extract a set of tasks from a calendar application associated with one or more users. In another example, an email exchange between two people may include text from a first person sending a request to a second person to perform a task. The email exchange may convey enough information for the system to automatically determine the presence of the request to perform the task. In some implementations, the email exchange does not convey enough information to determine the presence of a task. Whether or not this is the case, the system may query other sources of information that may be related to one or more portions of the email exchange. For example, the system may examine other messages exchanged by one or both of the authors of the email exchange or by other people. The system may also examine larger corpora of email and other messages. Beyond other messages, the system may query a calendar or database of one or both of the authors of the email exchange for additional information. In some implementations, the system may, among other things, query traffic or weather conditions at respective locations of one or both of the authors.

Herein, “extract” is used to describe determining or retrieving a task in an electronic communication or database. For example, a system may extract a task from a series of text messages. Here, the system is determining or identifying a task from the series of text messages, but is not necessarily removing the task from the series of text messages. In other words, “extract” in the context used herein, unless otherwise described for particular examples, does not mean to “remove”. In another example, a system may extract a task from an electronic calendar. Here, the system is retrieving a task from the calendar, but is not necessarily removing the task from the calendar.

Herein, a process of extracting a task from a communication may be described as a process of extracting “task content”. In other words, “task content” as described herein refers to one or more requests, one or more commitments, and/or projects comprising combinations of requests and commitments that are conveyed in the meaning of the communication. In various implementations, interplay between commitments and requests may be identified, extracted, and determined to be tasks. Such interplay, for example, may be where a commitment to a requester generates one or more requests directed to the requester and/or third parties (e.g., individuals, groups, processing components, and so on. For example, a commitment to a request from an engineering manager to complete a production yield analysis may generate secondary requests directed to a manufacturing team for production data.

In various implementations, a process may extract a fragment of text containing a task. For example, a paragraph may include a task in the second sentence of the paragraph. Additionally, the process may extract the text fragment, sentence, or paragraph that contains the task, such as the third sentence or various word phrases in the paragraph.

In various implementations, a process may augment extracted task content (e.g., requests or commitments) with identification of people and one or more locations associated with the extracted task content. For example, an extracted request may be stored or processed with additional information, such as identification of the requester and/or “requestee(s)”, pertinent location(s), times/dates, and so on.

Once identified and extracted by a computing system, a task (e.g., the proposal or affirmation of a commitment or request) of a communication may be further processed or analyzed to identify or infer semantics of the commitment or request including: identifying the primary owners of the request or commitment (e.g., if not the parties in the communication); the nature (e.g., type) of the task and its properties (e.g., its description or summarization); specified or inferred pertinent dates (e.g., deadlines for completing the commitment or request); relevant responses such as initial replies or follow-up messages and their expected timing (e.g., per expectations of courtesy or around efficient communications for task completion among people or per an organization); and information resources to be used to satisfy the request. Such information resources, for example, may provide information about time, people, locations, and so on. The identified task and inferences about the task may be used to drive automatic (e.g., computer generated) services such as reminders, revisions (e.g., and displays) of to-do lists, prioritization of tasks, appointments, meeting requests, and other time management activities. In some examples, such automatic services may be applied during the composition of a message (e.g., typing an email or text), reading the message, or at other times, such as during offline processing of email on a server or client device. The initial extraction and inferences about a task may also invoke automated services that work with one or more participants to confirm or refine current understandings or inferences about the task and the status of the task based, at least in part, on the identification of missing information or of uncertainties about one or more properties detected or inferred from the communication.

In some examples, task content may be extracted from multiple forms of communications, including any of a number of applications that involve task management, digital content capturing interpersonal communications (e.g., email, SMS text, instant messaging, phone calls, posts in social media, and so on) and composed content (e.g., email, calendars, note-taking and organizational tools such as OneNote® by Microsoft Corporation of Redmond, Wash., word-processing documents, and so on).

In some examples, a computing system may construct predictive models for identifying and extracting tasks and related information using machine learning procedures that operate on training sets of annotated corpora of sentences or messages (e.g., machine learning features). In other examples, a computing system may use relatively simple rule-based approaches to perform extractions and summarization. In still other examples, machine learning may utilize task execution tracking for a user. Such tracking may involve: user behavior and interests derived from an initial questionnaire and applying the behavior and interests to the way the user executes the task; recognition of intent of the user for the task; whether the user is performing a particular task type in a particular way based on the end goal of that task; pattern identification; determining how the user is faring on a particular time of a year, month, week, day for a particular task type (for example, if user is on a holiday, the user may only want to look at those tasks which will be more refreshing and lightweight); determining the external factors that influence the user's task initiation, execution, and completion (for example, such factors may be family commitments, health issues, vacation, long business trip, and so on); determining whether the user has a behavior style before, during, and after a task execution; determining whether the user is picking up the tasks on time; determining whether the user is completing the tasks on time; determining whether the user is postponing the tasks relatively frequently; determining whether there are any particular type of tasks that the user postpones; determining whether the user completes any high priority tasks; determining whether the user postpones tasks regardless of the type of the tasks (e.g., adhoc versus priority tasks); determining whether the user consciously responds to fly-out reminders for updating status of tasks; determining rate at which the user interacts with task updates frequently to update the task on time; determining rate at which the user postpones task updates; determining rate at which the user clears task lists by immediately picking up the next task as soon as the user is done with a task; determining a self-discipline trait of the user from the user's task follow-ups (for example, determining if the user sets up a meeting request, dies the user diligently sending minutes of the meeting to close the particular task); determining how the user behaves while executing a particular type of task (for example, the user may take twice as long to perform coding task as compared to design tasks); and tracking the user task execution sequence, just to name some examples.

In some examples, a computing system may explicitly notate task content extracted from a message in the message itself In various implementations, a computing system may flag messages containing tasks in multiple electronic services and experiences, which may include products or services such as revealed via products and services provided by Windows®, Cortana®, Outlook®, Outlook Web App® (OWA), Xbox®, Skype®, Lync® and Band®, all by Microsoft Corporation, and other such services and experiences from others. In various implementations, a computing system may extract tasks from audio feeds, such as from phone calls or voicemail messages, SMS images, instant messaging streams, and verbal requests to digital personal assistants, just to name a few examples.

In some examples, a computing system may learn to improve predictive models and summarization used for extracting tasks and categorizing or prioritizing the tasks using historical performance of a user for particular types of tasks. For example, a user may tend to demonstrate similar levels of performance for multiple tasks that are of a particular task type. Based, at least in part, on such historical data, which may be quantified and/or stored by the computer system and subsequently applied to predictive models (e.g., machine learning models), for example, efficient organization of resources (e.g., time and hardware) may be achieved.

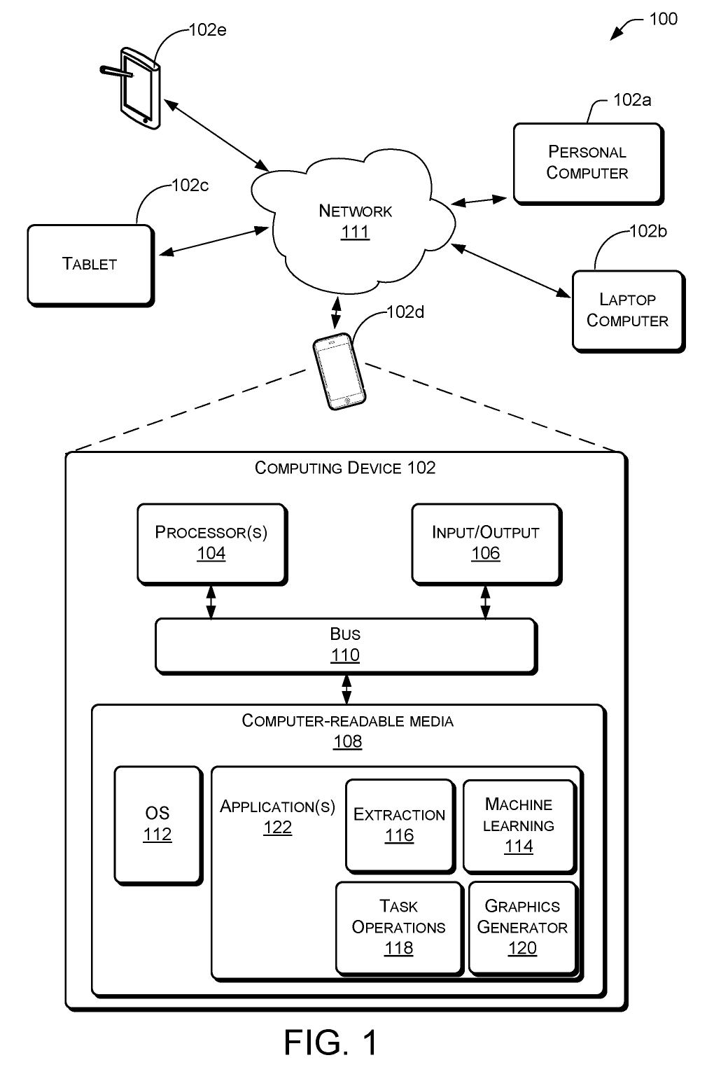

Various examples are described further with reference to FIGS. 1-12.

The environment described below constitutes but one example and is not intended to limit the claims to any one particular operating environment. Other environments may be used without departing from the spirit and scope of the claimed subject matter.

FIG. 1 illustrates an example environment 100 in which example processes involving task extraction, operations, and management as described herein can operate. In some examples, the various devices and/or components of environment 100 include a variety of computing devices 102. By way of example and not limitation, computing devices 102 may include devices 102a-102e. Although illustrated as a diverse variety of device types, computing devices 102 can be other device types and are not limited to the illustrated device types. Computing devices 102 can comprise any type of device with one or multiple processors 104 operably connected to an input/output interface 106 and computer-readable media 108, e.g., via a bus 110. Computing devices 102 can include personal computers such as, for example, desktop computers 102a, laptop computers 102b, tablet computers 102c, telecommunication devices 102d, personal digital assistants (PDAs) 102e, electronic book readers, wearable computers (e.g., smart watches, personal health tracking accessories, etc.), automotive computers, gaming devices, etc. Computing devices 102 can also include, for example, server computers, thin clients, terminals, and/or work stations. In some examples, computing devices 102 can include components for integration in a computing device, appliances, or other sorts of devices.

In some examples, some or all of the functionality described as being performed by computing devices 102 may be implemented by one or more remote peer computing devices, a remote server or servers, or distributed computing resources, e.g., via cloud computing. In some examples, a computing device 102 may comprise an input port to receive electronic communications. Computing device 102 may further comprise one or multiple processors 104 to access various sources of information related to or associated with particular electronic communications. Such sources may include electronic calendars (hereinafter, “calendars”) and databases of histories or personal information about authors of messages or other users included in the electronic communications, just to name a few examples. In some implementations, an author or user has to “opt-in” or take other affirmative action before any of the multiple processors 104 can access personal information of the author or user. In some examples, one or multiple processors 104 may be configured to extract task content from electronic communications. One or multiple processors 104 may be hardware processors or software processors. As used herein, a processing unit designates a hardware processor.

In some examples, as shown regarding device 102d, computer-readable media 108 can store instructions executable by the processor(s) 104 including an operating system (OS) 112, a machine learning module 114, an extraction module 116, a task operations module 118, a graphics generator 120, and programs or applications 122 that are loadable and executable by processor(s) 104. The one or more processors 104 may include one or more central processing units (CPUs), graphics processing units (GPUs), video buffer processors, and so on. In some implementations, machine learning module 114 comprises executable code stored in computer-readable media 108 and is executable by processor(s) 104 to collect information, locally or remotely by computing device 102, via input/output 106. The information may be associated with one or more of applications 122. Machine learning module 114 may selectively apply any of a number of machine learning decision models stored in computer-readable media 108 (or, more particularly, stored in machine learning module 114) to apply to input data.

In some implementations, extraction module 116 comprises executable code stored in computer-readable media 108 and is executable by processor(s) 104 to collect information, locally or remotely by computing device 102, via input/output 106. The information may be associated with one or more of applications 122. Extraction module 116 may selectively apply any of a number of statistical models or predictive models (e.g., via machine learning module 114) stored in computer-readable media 108 to apply to input data.

Though certain modules have been described as performing various operations, the modules are merely examples and the same or similar functionality may be performed by a greater or lesser number of modules. Moreover, the functions performed by the modules depicted need not necessarily be performed locally by a single device. Rather, some operations could be performed by a remote device (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some examples, computing device 102 can be associated with a camera capable of capturing images and/or video and/or a microphone capable of capturing audio. For example, input/output module 106 can incorporate such a camera and/or microphone. Images of objects or of text, for example, may be converted to text that corresponds to the content and/or meaning of the images and analyzed for task content. Audio of speech may be converted to text and analyzed for task content.

Computer readable media includes computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory (e.g., USB drives) or other memory technology, compact disk read-only memory (CD-ROM), external hard disks, digital versatile disks (DVD) or other optical storage, magnetic cassettes, magnetic tape, magnetic disk storage or other magnetic storage devices, or any other non-transmission medium that can be used to store information for access by a computing device.

In contrast, communication media embodies computer readable instructions, data structures, program modules, or other data in a modulated data signal, such as a carrier wave, or other transmission mechanism. As defined herein, computer storage media does not include communication media. In various examples, memory 108 is an example of computer storage media storing computer-executable instructions. When executed by processor(s) 104, the computer-executable instructions configure the processor(s) to, among other things, receive a task; extract at least one of an action, a subject, and a keyword from the task; search a history of execution of tasks (e.g., task types) that are similar to the task in a database; and categorize the task based, at least in part, on the history of execution of the similar tasks.

In various examples, an input device of or connected to input/output (I/O) interfaces 106 may be a direct-touch input device (e.g., a touch screen), an indirect-touch device (e.g., a touch pad), an indirect input device (e.g., a mouse, keyboard, a camera or camera array, etc.), or another type of non-tactile device, such as an audio input device.

Computing device(s) 102 may also include one or more input/output (I/O) interfaces 106, which may comprise one or more communications interfaces to enable wired or wireless communications between computing device 102 and other networked computing devices involved in extracting task content, or other computing devices, over network 111. Such communications interfaces may include one or more transceiver devices, e.g., network interface controllers (NICs) such as Ethernet NICs or other types of transceiver devices, to send and receive communications over a network. Processor 104 (e.g., a processing unit) may exchange data through the respective communications interfaces. In some examples, a communications interface may be a PCIe transceiver, and network 111 may be a PCIe bus. In some examples, the communications interface may include, but is not limited to, a transceiver for cellular (3G, 4G, or other), WI-FI, Ultra-wideband (UWB), BLUETOOTH, or satellite transmissions. The communications interface may include a wired I/O interface, such as an Ethernet interface, a serial interface, a Universal Serial Bus (USB) interface, an INFINIBAND interface, or other wired interfaces. For simplicity, these and other components are omitted from the illustrated computing device 102. Input/output (I/O) interfaces 106 may allow a device 102 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

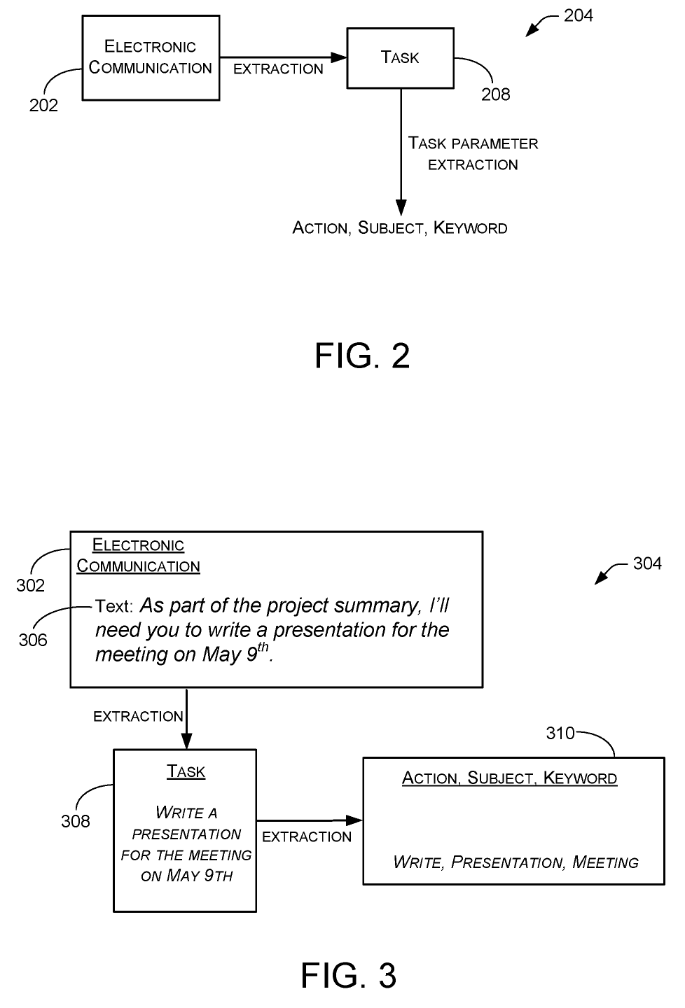

FIG. 2 is a block diagram illustrating electronic communication 202 subjected to an example task extraction process 204. For example, process 204 may involve any of a number of techniques for detecting whether task content is included in incoming or outgoing communications or in a database. Process 204 may also involve techniques for automatically marking, annotating, or otherwise identifying the message as containing task content. In some examples, process 204 may include techniques that extract a summary (not illustrated) of tasks for presentation and follow-up tracking and analysis. Task 206 may be extracted from multiple forms of content of electronic communication 202. Such content may include interpersonal communications such as email, SMS text or images, instant messaging, posts in social media, meeting notes, database content, and so on. Such content may also include content composed using email applications or word-processing applications, among other possibilities.

In some examples, task extraction process 204 may identify and extract task parameters, such as an action, a subject, and/or a keyword from task 208. As described below, an action, a subject, and a keyword, as well as other parameters, of a task may be used in a number of task operations, such as categorizing tasks, prioritizing the tasks, and so on.

Example techniques for identifying and extracting a task from various forms of electronic communications and for extracting an action, a subject, and a keyword from the task may involve language analysis of content of the electronic communications, which human annotators may annotate as containing tasks. For example, human annotations may be used in a process of generating a corpus of training data that is used to build and to test automated extraction of tasks and various properties about the tasks. Techniques may also involve proxies for human-generated labels (e.g., based on email engagement data or relatively sophisticated extraction methods). For developing methods used in extraction systems or for real-time usage of methods for identifying and/or inferring tasks or commitments and their properties, analyses may include natural language processing (NLP) analyses at different points along a spectrum of sophistication. For example, an analysis having a relatively low-level of sophistication may involve identifying key words based on simple word breaking and stemming. An analysis having a relatively mid-level of sophistication may involve consideration of larger analyses of sets of words (“bag of words”). An analysis having a relatively high-level of sophistication may involve sophisticated parsing of sentences in communications into parse trees and logical forms. Techniques for identifying and extracting task content may involve identifying attributes or “features” of components of messages and sentences of the messages. Such techniques may employ such features in a machine learning/training and testing paradigm to build a (e.g., statistical) model to classify components of the message. For example, such components may comprise sentences or the overall message as containing a task and also identify and/or summarize the text that best describes the task.

In some examples, techniques for extraction may involve a hierarchy of analysis, including using a sentence-centric approach, consideration of multiple sentences in a message, and global analyses of relatively long communication threads. In some implementations, such relatively long communication threads may include sets of messages over a period of time, and sets of threads and longer-term communications (e.g., spanning days, weeks, months, or years). Multiple sources of content associated with particular communications may be considered. Such sources may include histories and/or relationships of/among people associated with the particular communications, locations of the people during a period of time, calendar information of the people, and multiple aspects of organizations and details of organizational structure associated with the people.

In some examples, techniques may directly consider tasks identified from components of content as representative of the tasks, or may be further summarized. Techniques may extract other information from a sentence or larger message, including relevant dates (e.g., deadlines on which requests or commitments are due), locations, urgency, time-requirements, task subject matter (e.g., a project), and people. In some implementations, a property of extracted task content is determined by attributing tasks to particular authors of a message. This may be particularly useful in the case of multi-party emails with multiple recipients, for example.

Beyond text of a message, techniques may consider other information for extraction and summarization, such as images and other graphical content, the structure of the message, the subject header, length of the message, position of a sentence or phrase in the message, date/time the message was sent, and information on the sender and recipients of the message, just to name a few examples. Techniques may also consider features of the message itself (e.g., the number of recipients, number of replies, overall length, and so on) and the context (e.g., day of week). In some implementations, a technique may further refine or prioritize initial analyses of candidate messages/content or resulting extractions based, at least in part, on the sender or recipient(s) and histories of communication and/or of the structure of the organization.

In some examples, techniques may include analyzing features of various communications beyond a current communication (e.g., email, text, and so on). For example, techniques may consider interactions between or among tasks, such as whether an early portion of a communication thread contains a task, the number of tasks previously made between two (or more) users of the communication thread, and so on.

In some examples, techniques may include analyzing features of various communications that include conditional task content. For example, a conditional task may be “If I see him, I′ll let him know.” Another conditional task may be “If the weather is clear tomorrow, I′ll paint the house.”

In some examples, techniques may include augmenting extracted task content with additional information such as deadlines, identification (e.g., names, ID number, and so on) of people associated with the task content, and places that are mentioned in the task content.

FIG. 3 is a block diagram illustrating an electronic communication 302 that includes an example text thread and a task extraction process 304 of a task. For example, communication 302, which may be a text message to a user received on a computing device of the user from another user, includes text 306 from the other user. Task extraction process 304 includes analyzing content (e.g., text 306) of communication 302 and determining a task. In the example illustrated in FIG. 3, text 306 by the other user includes a task 308 that the user writes a presentation for a meeting on May 9^{th}. Task extraction process 304 may determine the task by any of a number of techniques involving analyzing text 306. In some implementations, if the text is insufficient for determining a task (e.g., “missing” information or highly uncertain information), then task extraction process 304 may query any of a number of data sources. For example, if text 306 did not include the date of the meeting (e.g., the other user may assume that the user remembers the date), then task extraction process 304 may query a calendar of the user or the other user for the meeting date.

In various examples, task extraction process 304 may determine likelihood (e.g., an inferred probability) or other measure of confidence that an incoming or outgoing message (e.g., email, text, etc.) contains a task intended for/by the recipient/sender. Such confidence or likelihood may be determined, at least in part, from calculated probabilities that one or more components of the message, or summarizations of the components, are valid requests or commitments of a candidate task.

In some examples, task extraction process 304 may identify and extract parameters 310, such as an action, a subject, and a keyword from task 308. In the example, an action of task 308 may be “write”, a subject of task 308 may be “presentation”, and a keyword of task 308 may be “meeting”. Such parameters may be used to categorize (e.g., establish a type of) task 308 or to determine a measure of importance of the task, as described below.

In some examples, a system performing task extraction process 304 may determine a measure of importance of a task, where a low-importance task is one for which the user would consider to be relatively low priority (e.g., low level of urgency) and a high-importance task is one for which the user would consider to be relatively high priority (e.g., high level of urgency). Importance of a task may be useful for subsequent operations such as prioritizing tasks, reminders, revisions of to-do lists, appointments, meeting requests, and other time management activities. Determining importance of a task may be based, at least in part, on history of events of the user (e.g., follow-through and performance of past tasks, and so on) and/or history of events of the other user and/or personal information (e.g., age, sex, age, occupation, frequent traveler, and so on) of the user or other user. For example, the system may query such histories. In some implementations, either or all of the users have to “opt-in” or take other affirmative action before the system may query personal information of the users. The system may assign a relatively high importance of a task for the user if such histories demonstrate that the user, for example, has been a principle member of the project for which the user is to write the presentation. Determining importance of a task may also be based, at least in part, on key words or terms in text 306. For example, “need” generally has implications of a required action, so that importance of a task may be relatively strong. On the other hand, in another example that involves a task of meeting a friend for tea, such an activity is generally optional, and such a task may thus be assigned a relatively low measure of importance. If such a task of meeting a friend is associated with a job (e.g., occupation) of the user, however, then such a task may be assigned a relatively high measure of importance. The system may weigh a number of such scenarios and factors to determine the importance of a task. For example, the system may determine importance of a task in a message based, at least in part, on content related to the electronic message.

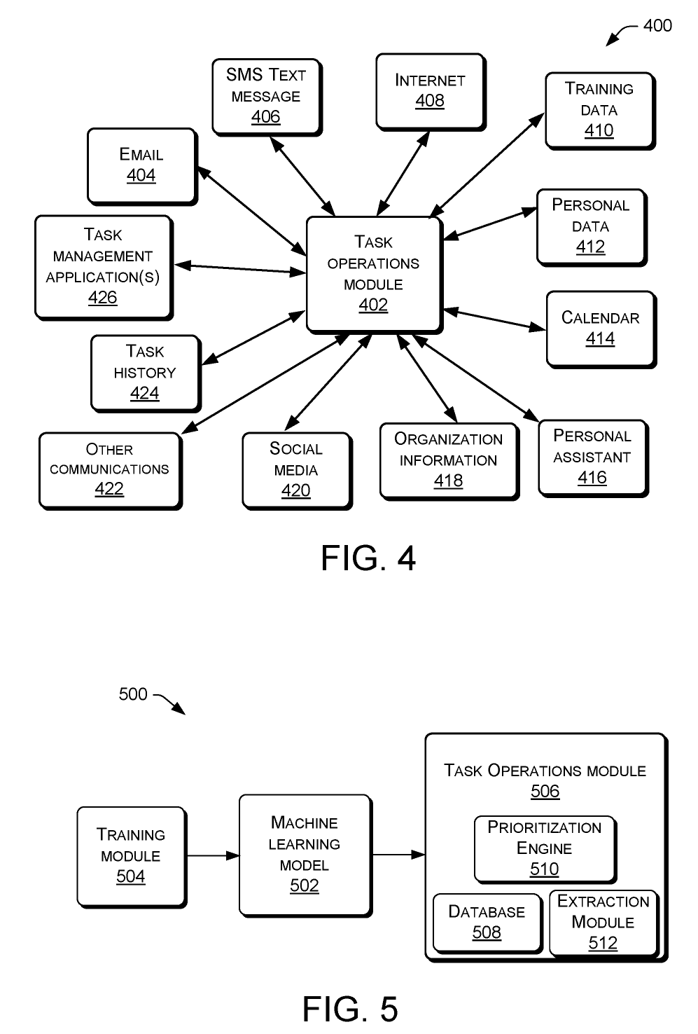

FIG. 4 is a block diagram of an example system 400 that includes a task operations module 402 in communication with a number of entities 404-426. Such entities may include host applications (e.g., Internet browsers, SMS text editors, email applications, electronic calendar functions, and so on), databases or information sources (e.g., personal data and histories of task performance of individuals, organizational information of businesses or agencies, third party data aggregators that might provide data as a service, and so on), just to name a few examples. Task operations module 402 may be the same as or similar to task operations module 118 in computing device 102, illustrated in FIG. 1, for example.

Task operations module 402 may be configured to analyze content of communications, and/or data or information provided by entities 404-426 by applying any of a number of language analysis techniques (though simple heuristical or rule-based systems may also be employed).

For example, task operations module 402 may be configured to analyze content of communications provided by email entity 404, SMS text message entity 406, and so on. Task operations module 402 may also be configured to analyze data or information provided by Internet entity 408, a machine learning entity providing training data 410, email entity 404, calendar entity 414, and so on. Task operations module 402 may analyze content by applying language analysis to information or data collected from any of entities 404-426. In some examples, task operations module 402 may be configured to analyze data regarding historic task interactions from task history entity 426, which may be a memory device. For example, such historic task interactions may include actions that people performed for previous tasks of similar types. Information about such actions (e.g., performance of a particular type of task, and so on) may indicate level of performance by people performing similar tasks. Accordingly, historic task interactions may be considered in decisions about current or future task operations. In some examples, a history of performance may include a user-preferred device for performing a particular type of task. For example, a user may be notified of a task via a portable device (e.g., smartphone) but historically tends to perform such a task using a desktop computer. In this example, the user-preferred device is the desktop computer. A user-preferred device may be determined from historical data as the device most commonly used by a user to perform particular types of tasks, for example.

In some examples, performance of a particular type of task by a user may be measured or quantified based on a number of features regarding the execution of (e.g., carrying-out) the particular type of task. Such features may include time spent completing the type of task, how often the type of task was completed or not completed, importance of the type of task in relation to how often the type of task was completed or not completed, whether the type of task is required or optional (e.g., work-based, personal, and so on), and what device(s) were used to execute the type of task, just to name a few examples.

Double-ended arrows in FIG. 4 indicate that data or information may flow in either or both directions among entities 404-426 and task operations module 402. For example, data or information flowing from task operations module 402 to any of entities 404-426 may result from task operations module 402 providing extracted task data to entities 404-426. In another example, data or information flowing from task operations module 402 to any of entities 404-426 may be part of a query generated by the task operations module to query the entities. Such a query may be used by task operations module 402 to determine one or more meanings of content provided by any of the entities, and determine and establish task-oriented processes based, at least in part, on the meanings of the content, as described below.

In some examples, task operations module 402 may receive content of an email exchange (e.g., a communication) among a number of users from email entity 404. The task operations module may analyze the content to determine one or more meanings of the content. Analyzing content may be performed by any of a number of techniques to determine meanings of elements of the content, such as words, phrases, sentences, metadata (e.g., size of emails, date created, and so on), images, and how and if such elements are interrelated, for example. “Meaning” of content may be how one would interpret the content in a natural language. For example, the meaning of content may include a request for a person to perform a task. In another example, the meaning of content may include a description of the task, a time by when the task should be completed, background information about the task, and so on. In another example, the meaning of content may include properties of desired action(s) or task(s) that may be extracted or inferred based, at least in part, on a learned model. For example, properties of a task may be how much time to set aside for such a task, should other people be involved, is this task high priority, and so on.

In an optional implementation, the task operations module may query content of one or more data sources, such as social media entity 420, for example. Such content of the one or more data sources may be related (e.g., related by subject, authors, dates, times, locations, and so on) to the content of the email exchange. Based, at least in part, on (i) the one or more meanings of the content of the email exchange and (ii) the content of the one or more data sources, task operations module 402 may automatically establish one or more task-oriented processes based, at least in part, on a request or commitment from the content of the email exchange.

In some examples, task operations module 402 may establish one or more task-oriented processes based, at least in part, on task content using predictive models learned from training data 410 and/or from real-time ongoing communications among the task operations module and any of entities 404-426. Predictive models may infer that an outgoing or incoming communication (e.g., message) or contents of the communication contain a task. The identification of tasks from incoming or outgoing communications may serve multiple functions that support the senders and receivers of the communications about the tasks. Such functions may be to generate and provide reminders to users, prioritize the tasks, revise to-do lists, and other time management activities. Such functions may also include finding or locating related digital artefacts (e.g., documents) that support completion of, or user comprehension of, a task activity.

In some examples, task operations module 402 may establish one or more task-oriented processes based, at least in part, on task content using statistical models to identify the proposing and affirming of commitments and requests from email received from email entity 404 or SMS text messages from SMS text message entity 406, just to name a few examples. Statistical models may be based, at least in part, on data or information from any or a combination of entities 404-426.

FIG. 5 is a block diagram of a machine learning system 500, according to various examples. Machine learning system 500 includes a machine learning model 502 (which may be similar to or the same as machine learning module 114, illustrated in FIG. 1), a training module 504, and a task operations module 506, which may be the same as or similar to task operations module 402, for example. Although illustrated as separate blocks, in some examples task operations module 506 may include machine learning model 502. Machine learning model 502 may receive training data from training module 504. For example, training data may include data from memory of a computing system that includes machine learning system 500 or from any combination of entities 404-426, illustrated in FIG. 4.

Telemetry data collected by fielding a task-related service (e.g., via Cortana® or other application) may be used to generate training data for many task-oriented actions. Relatively focused, small-scale deployments, e.g., longitudinally within a workgroup as a plugin to existing services such as Outlook® may yield sufficient training data to learn models capable of accurate inferences. In-situ surveys may collect data to complement behavioral logs, for example. User responses to inferences generated by a task operations module, for example, may help train a system over time.

Task operations module 506 may include a database 508 that stores a history of performance parameters for a number of tasks for a particular user. Such parameters may include time to complete particular types of tasks, categorization of tasks, and relative importance of tasks, just to name a few examples. Data from the memory or the entities may be used to train machine learning model 502. Subsequent to such training, machine learning model 502 may be employed by task operations module 506. Thus, for example, training using data from a history of task performance for offline training may act as initial conditions for the machine learning model. Other techniques for training, such as those involving featurization, described below, may be used.

Task operations module 506 may further include a prioritization engine 510 and an extraction module 512. Prioritization engine 510 may access database 508 to prioritize a set of tasks based, at least in part, on performance parameters for each of the set of tasks. Extraction module 512 may identify and extract parameters, such as an action, a subject, and a keyword from each of the set of tasks.

In some examples, task operations module 506 may determine behavior and interests of a user from answers to a questionnaire that assesses processes by which the user tends to perform such task. Follow-up processes may involve machine learning and may assess how the user is performing a particular task type in a particular way based on the end goal of that task, and how the user is faring at a particular time of a year, month, week, or day for a particular task type. For example, if the user is on a holiday, then the user may only want to look at tasks that will be relatively refreshing and lightweight. Follow-up processes may track the user task execution sequence and further assess: external factors (e.g., family commitments, health issues, vacations, long business trips, and so on) that influence a user's task initiation, execution & completion; whether the user has a behavior style before, during, or after a task execution; whether the user is picking up the tasks on time; whether the user is completing the tasks on time; whether the user is postponing the tasks relatively frequently; whether the user postpones any particular type of tasks; whether the user completes high priority tasks as compared to low priority tasks; whether the user postpones tasks regardless of the type of the tasks; whether the user responds to notifications or reminders for updating the status tasks; whether or how often the user is interacting with task updates; whether the user postpones task updates; whether the user clears the task list by immediately picking up a subsequent task as soon as being done with present task; and behavior of the user while executing a particular type of task. For example, a user may spend some time performing a coding task. However, the same user may spend double the time for design tasks.

In some examples, a system may assign task priority in alignment with past history of a user's task performance. For example, a user may historically demonstrate that high priority mail addressed only to the user takes more priority than a mail in which the user is cc'd or marked as FYI. In another example, if the user is working on a particular task, then portion of completion, start date, and end date may be combined to set the priority of the task. Accordingly, each task type may use combinations of certain aspects of the tasks to derive a pattern from machine learning results and to prioritize the tasks. Other aspects or parameters (e.g., fields) of tasks that may be considered include: task date, task keyword, task action, task subject, task start date, task end date, task update interval, task status, flagged status of task, day of the month task started, day of the month task completed, total work on task, actual work on task, percentage of task completed, task type, “To” email address field, “CC” email address field, day that last status of task is updated, day that final status of task is requested, last response date of task inquiry, and task priority, just to name some examples.

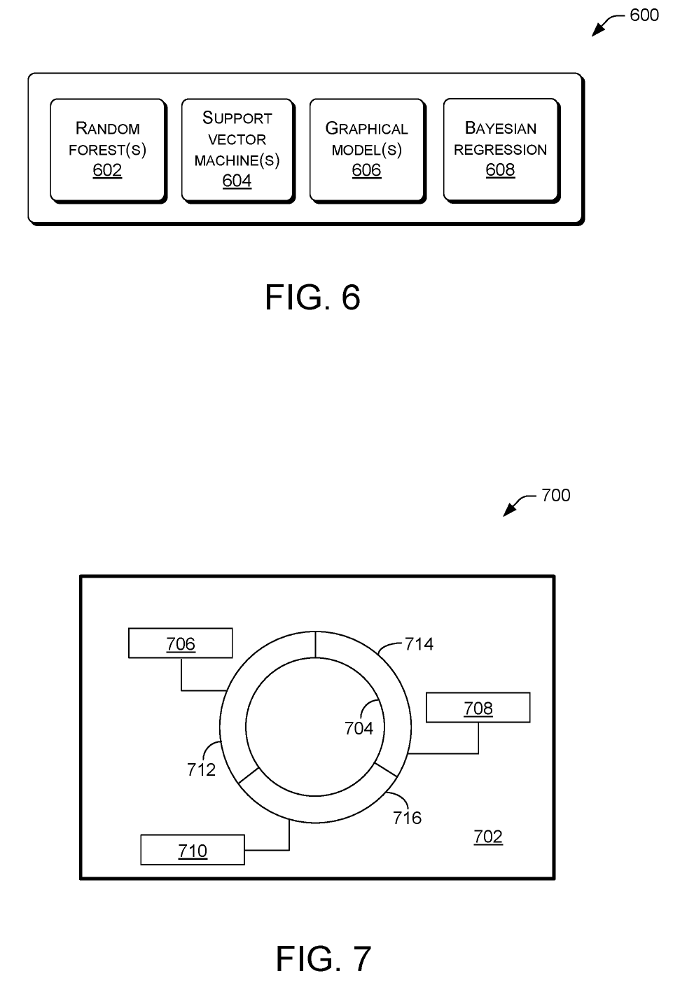

FIG. 6 is a block diagram of a machine learning model 600, according to various examples. Machine learning model 600 may be the same as or similar to machine learning model 502 shown in FIG. 5. Machine learning model 600 includes any of a number of functional blocks, such as random forest block 602, support vector machine block 604, and graphical models block 606. Random forest block 602 may include an ensemble learning method for classification that operates by constructing decision trees at training time. Random forest block 602 may output the class that is the mode of the classes output by individual trees, for example. Random forest block 602 may function as a framework including several interchangeable parts that can be mixed and matched to create a large number of particular models. Constructing a machine learning model in such a framework involves determining directions of decisions used in each node, determining types of predictors to use in each leaf, determining splitting objectives to optimize in each node, determining methods for injecting randomness into the trees, and so on.

Support vector machine block 604 classifies data for machine learning model 600. Support vector machine block 604 may function as a supervised learning model with associated learning algorithms that analyze data and recognize patterns, used for classification and regression analysis. For example, given a set of training data, each marked as belonging to one of two categories, a support vector machine training algorithm builds a machine learning model that assigns new training data into one category or the other.

Graphical models block 606 functions as a probabilistic model for which a graph is a probabilistic graphical model that shows conditional dependence and independence among random variables. Probabilistic graphical models represent the joint probability distribution over a set of variables of interest. Probabilistic inference algorithms operate on these graphical models to perform inferences based on specific evidence. The inferences provide updates about probabilities of interest, such as the probability that a message or that a particular sentence contains a task, or the probability that a user can perform a particular task in a particular amount of time. Learning procedures may construct such probabilistic models from data, with a process that discovers structure from a training set of unstructured information. Learning procedures may also construct such probabilistic models from explicit feedback from users (e.g., confirming whether extracted task information is correct or not). Applications of graphical models, which may be used to infer task content from non-text content, may include information extraction, speech recognition, image recognition, computer vision, and decoding of low-density parity-check codes, just to name a few examples. In some examples, machine learning model 600 may further include a Bayesian regression block 608.

FIG. 7 is a view of a display 700 showing an example graphic 702 including visual cues of tasks. A system, such as graphics generator 120, for example, may configure graphic 702 to readily allow a user to maintain or establish awareness of a pending set of tasks by representing each task as a portion of a geometrical pattern 704, such as a circle, for instance. Graphic 702 may provide a reminder to the user in a visual way by linking tasks to their respective parameters, namely task action, task subject, and task keyword.

Example graphic 702 visually depicts three tasks 706, 708, and 710, each represented as a text box respectively situated adjacent to a portion 712, 714, and 716 of geometrical pattern 704. Each of portions 712, 714, 716 may comprise a portion of geometrical pattern 704 that is proportional to a particular aspect of the corresponding task. In some examples, each of portions 712, 714, 716 may be colored or textured to represent a particular aspect of the corresponding task. Such aspects of a task may include priority, importance, classification (e.g., work-related, personal), and estimated time for completion, just to name a few examples. Graphic 702 may provide an opportunity for the user to enter or modify information about each task. The system may annotate or highlight various portions of graphic 702 in any of a number of ways to convey details regarding each of a set of tasks

In some examples, the system may populate graphic 702 with information about a set of tasks. The system, via task operations module 402, for example, may add relevant information to graphic 702 during the display of the graphic. For example, such relevant information may be inferred from additional sources of data or information, such as from entities 404-426. In a particular example, a system that includes task operations module 402 may display a task in graphic 702. The task is for the user to attend a type of class. Task operations module 402 may query Internet 408 to determine that a number of such classes are offered in various locations and at various times of day in an area where the user resides (e.g., which may be inferred from personal data 412 regarding the user). Accordingly, the task operations module may generate and provide a list of choices or suggestions to the user via graphic 702. Such a list may be dynamically displayed near text of pertinent portions of graphic 702 in response to mouse-over, or may be statically displayed in other portions of the display, for example. In some examples, the list may include items that are selectable (e.g., by a mouse click) by the user so that the task will include a time selected by the user (this time may replace a time “suggested” originally by the task in graphic 702).

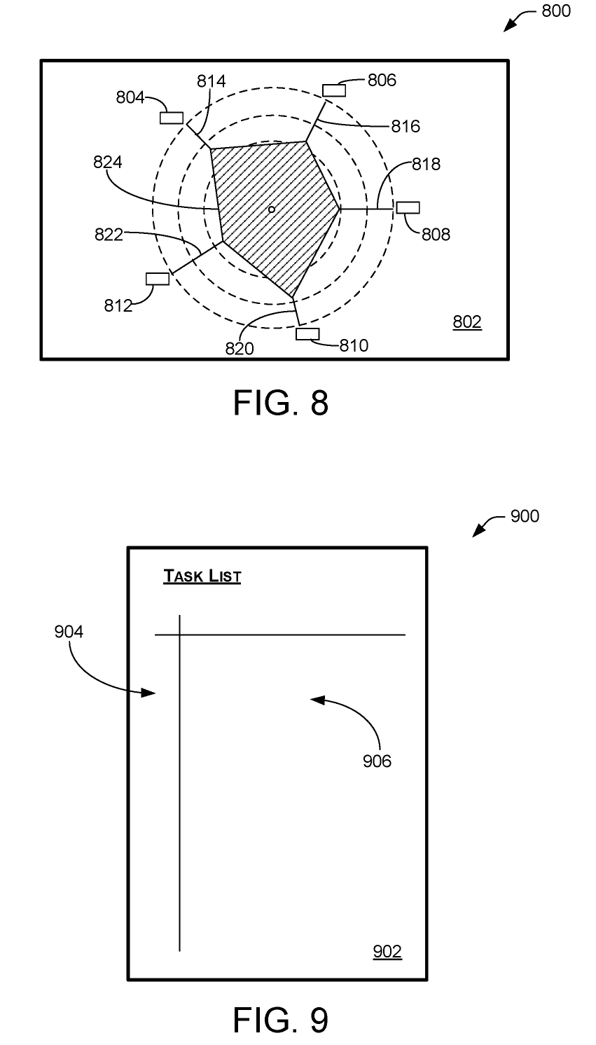

FIG. 8 is a view of a display 800 showing an example productivity graphic 802 depicting productivity (e.g., a productivity report) of a user for performing each of a set of tasks, 804, 806, 808, 810, and 812, each having a corresponding axis 814, 816, 818, 820, and 822, respectively. Productivity graphic 802 may help the user analyze time spent on each task category over a period of time. A system may determine productivity of the user by, for example, using a process to deduce time spent and effects of this time spent on the user's overall performance in that period of time. The system may use graphics generator 120, for example, to generate productivity graphic 802.

Productivity for a task is proportional to the coverage of the corresponding axis for the task by pattern 824. For example, productivity for task 804 is proportional to the coverage of axis 814 by pattern 824, productivity for task 806 is proportional to the coverage of axis 816 by pattern 824, productivity for task 808 is proportional to the coverage of axis 818 by pattern 824, and so on. A resulting shape of pattern 824 may allow the user to visually ascertain productivity for each of the tasks. Productivity graphic 802 may be configured for any time interval (e.g., hours, a day, week, month, etc.).

FIG. 9 is a view of a display 900 showing an example task list 902, which may include a prioritization field 904 of a list of tasks 906. A system may use a prioritization engine, such as 510, to prioritize the tasks by using task parameters (e.g., 310, illustrated in FIG. 3) and results of machine learning, as described above. Such machine learning may also be used to predict the time a user takes to perform particular tasks based, at least in part, on a particular task type and on the task parameters. The system may order the list of tasks 906 by identifying or determining relative importance or urgency of each of the tasks. Task list 902 may change dynamically during display in response, for example, to changing conditions, which may be determined by a task operations module (e.g., 402). In some examples, task list 902 may depict the portion of the day (e.g., time range) and the amount of time (e.g., duration) to be allocated to particular tasks.

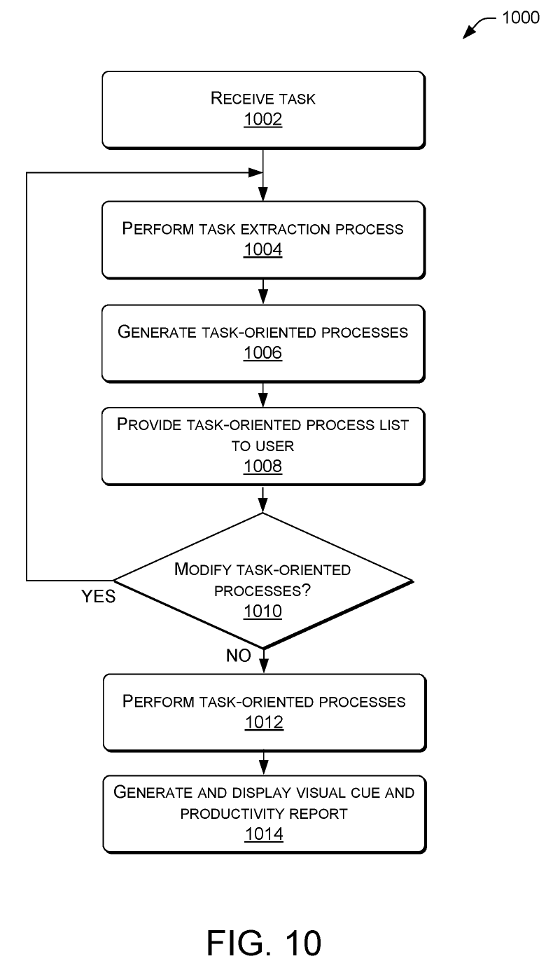

FIG. 10 is a flow diagram of a process 1000 for performing task-oriented processes based, at least in part, on a task. For example, task operations module 402, illustrated in FIG. 4, may perform process 1000. At block 1002, task operations module 402 may receive a task, such as by retrieving the task from any entities 404-426, from a message, such as an email, text message, or any other type of communication between or among people or machines (e.g., computer systems capable of generating messages), or by direct input (e.g., text format) via a user interface. At block 1004, task operations module 402 may perform task extraction processes, as described above.

At block 1006, task operations module 402 may generate one or more task-oriented actions based, at least in part, on the determined task content. Such actions may include prioritizing the task relative to a number of other tasks, modifying electronic calendars or to-do lists, providing suggestions of possible user actions, and providing reminders to users, just to name a few examples. In some examples, task operations module 402 may generate or determine task-oriented processes by making inferences about nature and timing of “ideal” actions, based on determined task content (e.g., estimates of a user-desired duration). In some examples, task operations module 402 may generate or determine task-oriented processes by automatically identifying and promoting different action types based on the nature of a determined task (e.g., “write report by 3pm” may require setting aside time, whereas “let me know by 3pm” suggests the need for a reminder).

At block 1008, task operations module 402 may provide a list of the task-oriented actions to the user for inspection or review. For example, a task-oriented action may be to find or locate digital artefacts (e.g., documents) related to a particular task to support completion of, or user comprehension of, a task activity. At diamond 1010, the user may select among choices of different possible actions to be performed by task operations module 402, refine possible actions, delete actions, manually add actions, and so on. If there are any such changes, then process 1000 may return to block 1004 where task operations module 402 may re-generate task-oriented processes in view of the user's edits of the task-oriented process list. On the other hand, if the user approves the list, then process 1000 may proceed to block 1012 where task operations module 402 performs the task-oriented processes. At block 1014, the task operations module may generate and display a visual cue and productivity report, for example.

In some examples, task-oriented processes may involve: generating ranked lists of tasks (e.g., prioritized list of tasks); task-related inferring, extracting, and using inferred dates, locations, intentions, and appropriate next-steps; providing key data fields for display that are relatively easy to modify; tracking life histories of tasks with multistep analyses, including grouping tasks into higher-order tasks or projects to provide support for people to achieve such tasks or projects; iteratively modifying a schedule for one or more authors of an electronic message over a period of time (e.g., initially establishing a schedule and modifying the schedule a few days later based, at least in part, on events that occur during those few days); integrating to-do lists with reminders; integrating larger time-management systems with manual and automated analyses of required time and scheduling services; linking to automated and/or manual delegation; and integrating real-time composition tools having an ability to deliver task-oriented goals based on time required (e.g., to help users avoid overpromising based on other constraints on the user's time). Inferences may be personalized to individual users or user cohorts based on historical data, for example.

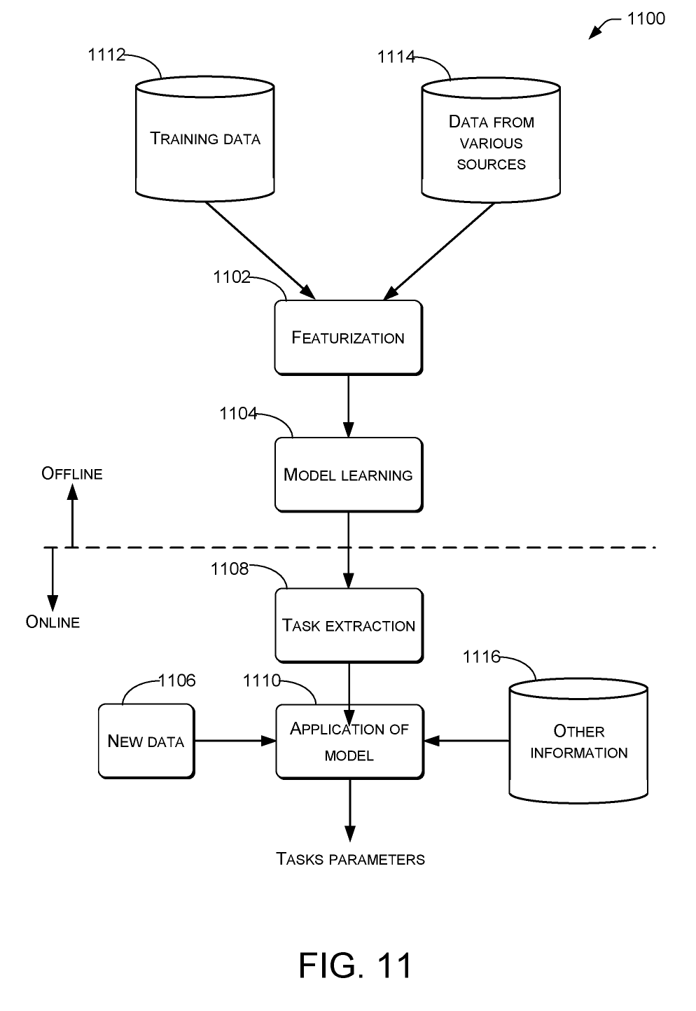

FIG. 11 is a block diagram illustrating example online and offline processes 1100 involved in commitment and request extraction. Such processes may be performed by a processor (e.g., a processing unit) or a computing device, such as computing device 102 described above. “Offline” refers to a training phase in which a machine learning algorithm is trained using supervised/labeled training data (e.g., a set of tasks and their associated parameters). “Online” refers to an application of models that have been trained to extract tasks from new (unseen) data of any of a number of types of sources. A featurization process 1102 and a model learning process 1104 may be performed by the computing device offline or online. On the other hand, receiving new data 1106, task extraction 1108, and the process 1110 of applying the model may occur online.

In some examples, any or all of featurization process 1102, model learning process 1104, and the process 1110 of applying the model may be performed by an extraction module, such as extraction module 116 or 512. In other examples, featurization process 1102 and/or model learning process 1104 may be performed by a machine learning module (e.g., machine learning module 114, illustrated in FIG. 1), and the process 1110 of applying the model may be performed by an extraction module.

In some examples, featurization process 1102 may receive training data 1112 and data 1114 from various sources, such as any of entities 404-426, illustrated in FIG. 4. Featurization process 1102 may generate feature sets of text fragments that are helpful for classification. Text fragments may comprise portions of content of one or more communications (e.g., generally a relatively large number of communications of training data 1112). For example, text fragments may be words, terms, phrases, or combinations thereof. Model learning process 1104 is a machine learning process that generates and iteratively improves a model used in process 1108 for extracting task content, such as requests and commitments, from communications. For example, the model may be applied to new data 1106 (e.g., email, text, database, and so on). A computing device may perform model learning process 1104 continuously, from time to time, or periodically, asynchronously from the process 1110 of applying the model to new data 1106. Thus, for example, model learning process 1104 may update or improve the model offline and independently from online process such as applying the model (or a current version of the model) to new data 1106.

The process 1110 of applying the model to new data 1106 may involve consideration of other information 1116, which may be received from entities such as 404-426, described above. In some implementations, at least a portion of data 1114 from other sources may be the same as other information 1116. The process 1108 of applying the model may result in extraction of task content included in new data 1106. Such task content may include a task and its parameters.

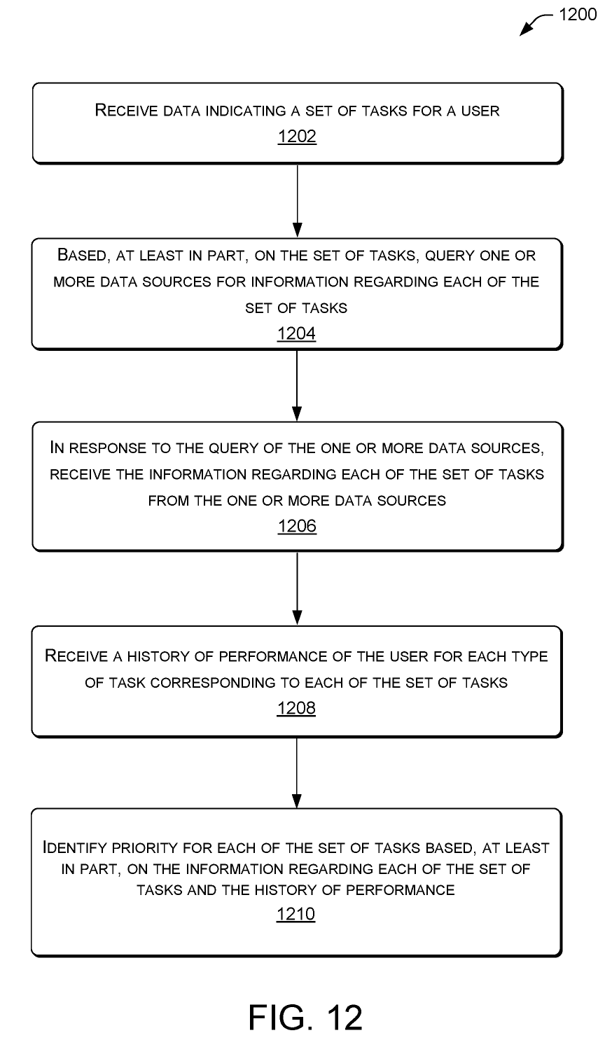

FIG. 12 is a flow diagram of an example task extraction process 1200 that may be performed by a task operations module (e.g., 118) or a processor (e.g., 104). For example, process 1200 may be performed by computing device 102 (e.g., extraction module 116), illustrated in FIG. 1, or more specifically, in other examples, may be performed by extraction module 502, illustrated in FIG. 5.

At block 1202, the task operations module may receive data indicating a set of tasks for a user. For example, such tasks may be received or detected from entities such as 404-426 or manually entered via a user interface. At block 1204, the task operations module may, based at least in part on the set of tasks, query one or more data sources for information regarding each of the set of tasks. For example, one or more data sources may include any of entities 404-426 described in the example of FIG. 4. In another example, one or more data sources may include any portion of computer-readable media 108, described in the example of FIG. 1.

At block 1206, the task operations module may, in response to the query of the one or more data sources, receive the information regarding each of the set of tasks from the one or more data sources. At block 1208, the task operations module may receive a history of performance of the user for each type of task corresponding to each of the set of tasks.

At block 1210, the task operations module may identify importance or urgency for each of the set of tasks based, at least in part, on the information regarding each of the set of tasks and the history of performance.

The flow of operations illustrated in FIG. 12 is illustrated as a collection of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor(s) to perform the recited operations. In the context of hardware, the blocks may represent one or more circuits (e.g., FPGAs, application specific integrated circuits—ASICs, etc.) configured to execute the recited operations.

Any descriptions, elements, or blocks in the flows of operations illustrated in FIG. 12 may represent modules, segments, or portions of code that include one or more executable instructions for implementing specific logical functions or elements in the process.

### Example Clauses

A. A system comprising: a processor; a memory accessible by the processor; a machine learning module stored in the memory and executable by the processor to generate at least a portion of a database containing parameters representative of performance of a first task that is a particular type of task; an input port configured to receive information regarding a second task from one or more data sources, wherein the second task is the particular type of task; and a task operations module configured to set a level of priority of the second task based, at least in part, on the parameters representative of the performance of the first task.

B. The system as paragraph A recites, wherein the task operations module includes an extractor engine configured to extract an action, a subj ect, and a keyword from the second task based, at least in part, on identifying attributes of the second task from the one or more data sources.

C. The system as paragraph B recites, further comprising a graphics generator configured to generate a visual cue of the second task based, at least in part, on the action, the subject, and the keyword.

D. The system as paragraph A recites, wherein the performance of the first task comprises a history of performance of additional tasks each being the particular type of task.

E. The system as paragraph A recites, wherein the input port is further configured to receive task attributes of the second task from the one or more data sources, and wherein the task operations module is configured to set the level of priority of the second task based, at least in part, on the task attributes.

F. The system as paragraph E recites, wherein the task attributes comprise parameters of task type.

G. The system as paragraph A recites, wherein the one or more data sources comprise one or more personal databases of a user and the parameters representative of performance of the first task comprise parameters representative of performance of the user for the particular type of task.

H. The system as paragraph G recites, wherein the parameters representative of performance of the user for the first task include a predicted behavior of the user for the first task.

I. The system as paragraph A recites, wherein the machine learning module is further configured to use the information regarding the second task as training data.

J. The system as paragraph A recites, wherein the task operations module is configured to categorize the second task in real time.

K. A method comprising: receiving data indicating a set of tasks for a user; based, at least in part, on the set of tasks, querying one or more data sources for information regarding each of the set of tasks; and in response to the query of the one or more data sources, receiving the information regarding each of the set of tasks from the one or more data sources; receiving a history of performance of the user for each type of task corresponding to each of the set of tasks, respectively; and identifying priority for each of the set of tasks based, at least in part, on the information regarding each of the set of tasks and the history of performance.

L. The method as paragraph K recites, wherein the history of performance includes a user-preferred device for each of the types of tasks.

M. The method as paragraph K recites, further comprising: applying the information regarding each of the set of tasks received from the one or more data sources as training data for a machine learning process to generate the history of performance of the user.

N. The method as paragraph K recites, further comprising: generating a productivity report based, at least in part, on the history of performance of the user.

O. A computing device comprising: a transceiver port to receive and to transmit data; one or more processors; and a memory storing instructions that, when executed by the one or more processors, cause the one or more processors to perform operations comprising: receive data indicating a task via the transceiver port; extract at least one of an action, a subject, and a keyword from the data indicating the task; search in a database for a history of execution of similar tasks that are similar to the task; and categorize the task based, at least in part, on the history of execution of the similar tasks and the action, the subject, or the keyword extracted from the task.

P. The computing device as paragraph O recites, wherein the operations further comprise: receiving information regarding the task from one or more data sources; and determining importance of the task based, at least in part, on the received information.

Q. The computing device as paragraph P recites, wherein the one or more data sources include a calendar, and email account.

R. The computing device as paragraph P recites, wherein the operations further comprise: applying the information regarding the task from the one or more data sources as training data for a machine learning process.

S. The computing device as paragraph O recites, wherein categorizing the task is performed using a machine learning process.

T. The computing device as paragraph O recites, further comprising: an electronic display, and wherein the operations further comprise causing an image to be displayed on the electronic display, wherein the image includes a visual representation of a productivity report of the task.

Although the techniques have been described in language specific to structural features and/or methodological acts, it is to be understood that the appended claims are not necessarily limited to the features or acts described. Rather, the features and acts are described as example implementations of such techniques.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “might” or “may,” unless specifically stated otherwise, are used to indicate that certain examples include, while other examples do not include, the noted features, elements and/or steps. Thus, unless otherwise stated, such conditional language is not intended to imply that features, elements and/or steps are in any way required for one or more examples or that one or more examples necessarily include logic for deciding, with or without user input or prompting, whether these features, elements and/or steps are included or are to be performed in any particular example.

Conjunctive language such as the phrase “at least one of X, Y or Z,” unless specifically stated otherwise, is to be understood to present that an item, term, etc. may be either X, or Y, or Z, or a combination thereof.

Many variations and modifications may be made to the above-described examples, the elements of which are to be understood as being among other acceptable examples. All such modifications and variations are intended to be included herein within the scope of this disclosure.

What is claimed is:

1. A system comprising:
a processor;
a memory accessible by the processor;
a machine learning module stored in the memory and executable by the processor to generate at least a portion of a database containing parameters representative of performance of a first task that is a particular type of task;
an input port configured to receive information regarding a second task from one or more data sources, wherein the second task is the particular type of task; and
a task operations module configured to set a level of priority of the second task based, at least in part, on the parameters representative of the performance of the first task.

2. The system of claim 1, wherein the task operations module includes an extractor engine configured to extract an action, a subject, and a keyword from the second task based, at least in part, on identifying attributes of the second task from the one or more data sources.

3. The system of claim 2, further comprising a graphics generator configured to generate a visual cue of the second task based, at least in part, on the action, the subject, and the keyword.

4. The system of claim 1, wherein the performance of the first task comprises a history of performance of additional tasks each being the particular type of task.

5. The system of claim 1, wherein the input port is further configured to receive task attributes of the second task from the one or more data sources, and wherein the task operations module is configured to set the level of priority of the second task based, at least in part, on the task attributes.

6. The system of claim 5, wherein the task attributes comprise parameters of task type.

7. The system of claim 1, wherein the one or more data sources comprise one or more personal databases of a user and the parameters representative of performance of the first task comprise parameters representative of performance of the user for the particular type of task.

8. The system of claim 7, wherein the parameters representative of performance of the user for the first task include a predicted behavior of the user for the first task.

9. The system of claim 1, wherein the machine learning module is further configured to use the information regarding the second task as training data.

10. The system of claim 1, wherein the task operations module is configured to categorize the second task in real time.

11. A method comprising:
receiving data indicating a set of tasks for a user;
based, at least in part, on the set of tasks, querying one or more data sources for information regarding each of the set of tasks; and
in response to the query of the one or more data sources, receiving the information regarding each of the set of tasks from the one or more data sources;
receiving a history of performance of the user for each type of task corresponding to each of the set of tasks, respectively; and
identifying priority for each of the set of tasks based, at least in part, on the information regarding each of the set of tasks and the history of performance.

12. The method of claim 11, wherein the history of performance includes a user-preferred device for each of the types of tasks.

13. The method of claim 11, further comprising:
applying the information regarding each of the set of tasks received from the one or more data sources as training data for a machine learning process to generate the history of performance of the user.

14. The method of claim 11, further comprising:
generating a productivity report based, at least in part, on the history of performance of the user.

15. A computing device comprising:
a transceiver port to receive and to transmit data;
one or more processors; and
a memory storing instructions that, when executed by the one or more processors, cause the one or more processors to perform operations comprising:
receive data indicating a task via the transceiver port;
extract at least one of an action, a subject, and a keyword from the data indicating the task;
search in a database for a history of execution of similar tasks that are similar to the task; and
categorize the task based, at least in part, on the history of execution of the similar tasks and the action, the subject, or the keyword extracted from the task.

16. The computing device of claim 15, wherein the operations further comprise:
receiving information regarding the task from one or more data sources; and
determining importance of the task based, at least in part, on the received information.

17. The computing device of claim 16, wherein the one or more data sources include a calendar, and email account.

18. The computing device of claim 16, wherein the operations further comprise:
applying the information regarding the task from the one or more data sources as training data for a machine learning process.

19. The computing device of claim 15, wherein categorizing the task is performed using a machine learning process.

20. The computing device of claim 15, further comprising:
an electronic display, and wherein the operations further comprise causing an image to be displayed on the electronic display, wherein the image includes a visual representation of a productivity report of the task.
